(19) United States
(12) Patent Application Publication
(10) Pub. No.: US 2017/0061755 A1
(43) Pub. Date: Mar. 2, 2017

(54) WARNING DEVICE

(71) Applicant: PON-WEI HOU, Hsinchu City (TW)

(72) Inventor: PON-WEI HOU, Hsinchu City (TW)

(21) Appl. No.: 14/835,706

(22) Filed: Aug. 25, 2015

(51) Int. Cl. G08B 7/06; H04W 4/02

(52) U.S. Cl. CPC G08B 7/06; H04W 4/02

(57) ABSTRACT

A warning device is disclosed. The warning device includes at least: a board, a locating unit installed on the board and a real-time monitoring unit installed close to the board for users to carry. A number of reflective elements and a number of luminous elements electrically connected to a power module are installed on the board so that warning light beams can be actively sent out. The locating unit can generate a first locating information and the location where the board is can be known by a sent signal. The real-time monitoring unit can work with the signal sent from the locating unit to point out the location where the user is by warning sounds to have effects of warning and monitoring.

### BACKGROUND OF THE INVENTION

1. Field of the Invention

The present invention relates to a warning device. More particularly, the present invention relates to a warning device which is able to actively send warning light beams, process monitoring and provide warning sound to tell the users where they are.

2. Related Art

If a car is out of order when it is on the way to somewhere, a warning triangle will be placed on the rear side of the fault car to warn other cars come behind. Current warning triangles works based on reflective light beams. In the daytime, drivers can see the warning triangle far away. However, if it is in the evening or a foggy day, light beams for reflection are not sufficient so that the warning triangle can not be seen clearly, further causing vehicle rear-end accident. The fault car owner can not be noticed before the accident happens.

In addition, people are anxiously looking for their children who lose the way. Similarly, no matter old people, dementia patients, or even mountaineers, people in the ship wreck and air crash, they need to be found. It must be helpful if popular wireless communication products or smart phones can be linked to a warning element equipped by people who need help to develop more relative functions.

The inventor knows that existing warning signs need to be improved. Therefore, based on his seasoned experiences in the past and multi-assessment, an innovation warning device is provided to effectively settle the problems mentioned above.

### SUMMARY OF THE INVENTION

An object of the present invention is to provide a warning device capable of sending out light beams for warning function, and also generating locating information for positioning function.

Another object of the present invention is to provide a warning device capable of producing warning sounds along with the positioning function to point out the location where the user is.

To attain this, the warning device includes: a board having an inner side surface and an outer side surface in the opposite of the inner side surface, the inner side surface having a power module connected to an external power supply or accommodating batteries, the outer side surface being installed with a number of reflective elements and a number of luminous elements connected to the power module; and a locating unit electrically connected to the power module and installed on the inner side surface of the board, the locating unit comprising: a locater, an encoder, a first memory and a signal transmitter, the locater generating a first locating information for recording a location of the board, the encoder calculating and converting the first locating information to store in the first memory, the signal transmitter fetching a calculated and converted first locating information from the first memory and transmitting it in the form of radio signal.

In according with the present invention, the warning device further comprises a real-time monitoring unit located close to the board and wirelessly connected with the locating unit. The real-time monitoring unit comprises: a body, and a signal receiver, a decoder, a second memory, a processor and a buzzer which are assembled in the body. The signal receiver receives the radio signal from the locating unit. The decoder decodes the radio signal and stores the decoded radio signal in the second memory. The processor fetches the decoded radio signal from the second memory and actively feeds back the decoded radio signal and directly initiates the buzzer. Thus, once the first locating information generated from the locating unit is transmitted, with the real-time monitoring unit actively feeding back the decoded radio signal and initiating the buzzer, light warnings, locating warnings, monitoring effects and sound warnings are provided, so that users can be aware of where they are thereby.

In according with the present invention, the luminous elements comprise a plurality of first luminous elements and second luminous elements, wherein the first luminous elements and the reflective elements are interleavedly arranged on the outer side surface, and the second luminous elements are installed outside the first luminous elements and the reflective elements and close to an upper edge of the outer side surface, and colors of the luminous elements are of high brightness and good penetration such as red, yellow and orange so that cars far away are able to quickly perceive the luminous elements even under a poor sight condition to strength the effect of warning.

In according with the present invention, the board is a standard traffic sign and a contour of the traffic sign is in triangular, circular or other contour shapes, wherein the reflective elements are arranged as a strip shape in a central part of the outer side surface and also as a ring shape in an edge part thereof to show a traffic sign representing “no entry”, and further, the luminous elements are arranged on surfaces of the reflective elements to enhance warning effect of the traffic sign.

In according with the present invention, a contour of the board is made according to user preferences as a shape of a lovely badge such as a gingerbread man, wherein the reflective elements are integrally formed to cover the outer side surface of the board, and surfaces of the reflective elements are arranged with the luminous elements, and when the board with the real-time monitoring unit is equipped by children and their caregivers, old people, dementia patients or mountaineers and people during ship wreck and air crash, in addition to light warning from the reflective elements and the luminous elements on the board, the real-time monitoring unit is able to actively feed back the decoded radio signal and initiate the buzzer to provide monitoring effects and sound warnings to point out where the user is.

### BRIEF DESCRIPTION OF THE DRAWINGS

FIG. 1 is a block diagram of a warning device in a first embodiment of the present invention;

FIG. 2A is a schematic view illustrating an outer side surface of a board in the first embodiment;

FIG. 2B is a schematic view illustrating an inner side surface of the board in the first embodiment of the present invention;

FIG. 3A is a schematic view illustrating an outer side surface of a board in a second embodiment of the present invention;

FIG. 3B is a schematic view illustrating an inner side surface of the board in the second embodiment of the present invention;

FIG. 4A is a schematic view illustrating an outer side surface of a board in a third embodiment of the present invention;

FIG. 4B is a schematic view illustrating an inner side surface of the board in the third embodiment of the present invention.

### DESCRIPTION OF THE PREFERRED EMBODIMENTS

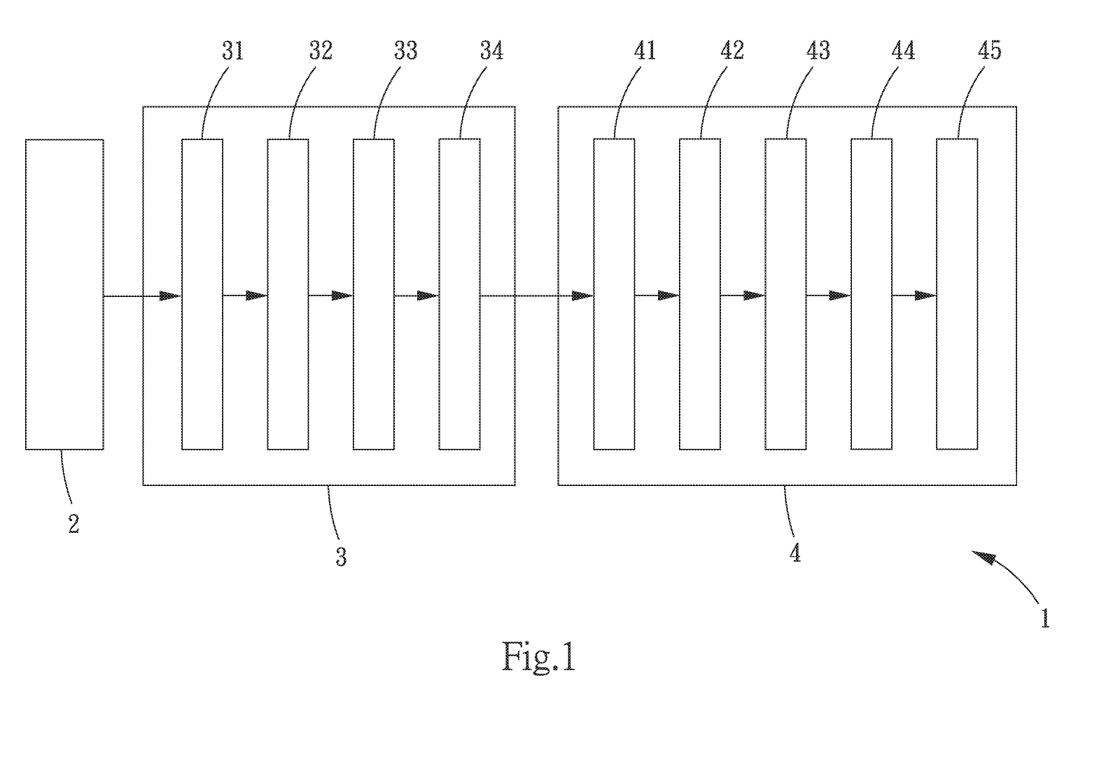

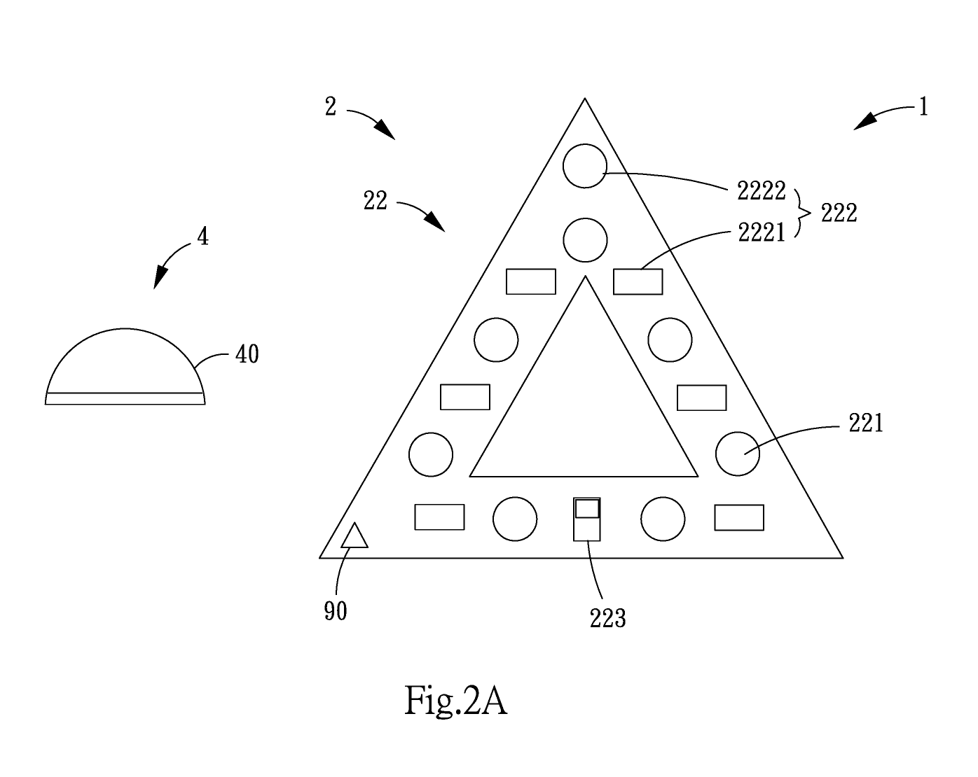

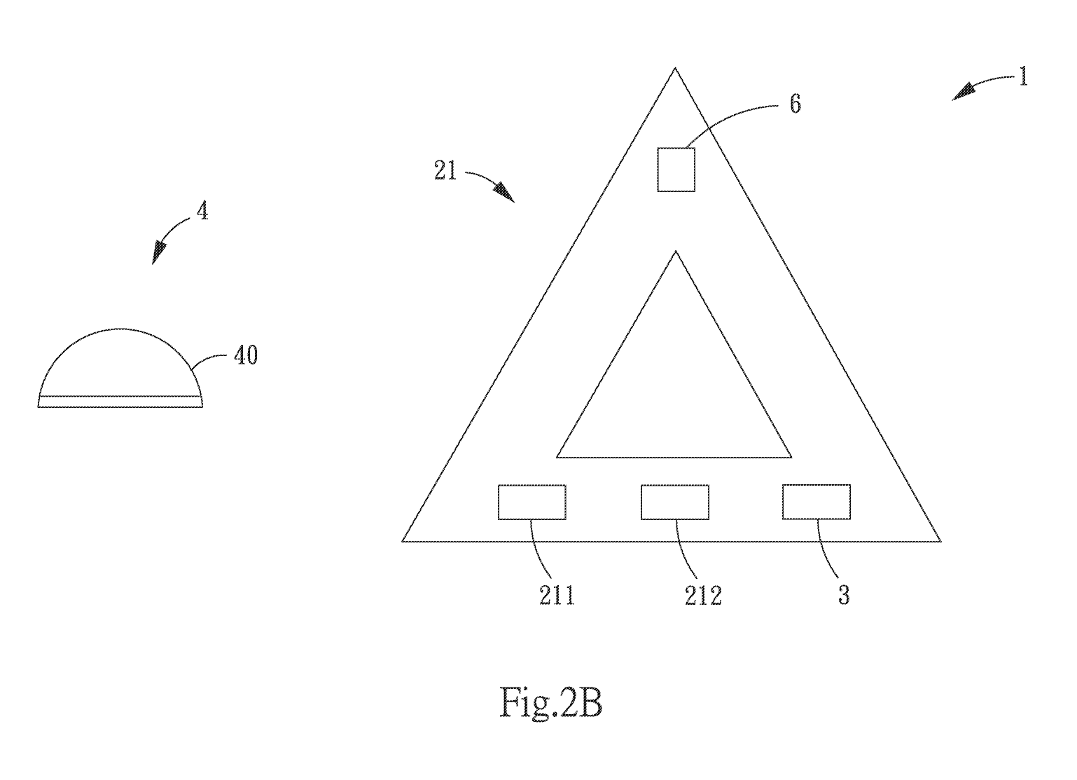

Please refer to FIG. 1, FIG. 2A and FIG. 2B as a first embodiment of the present invention. A warning device 1 of the present invention includes a board 2, a locating unit 3 and a real-time monitoring unit 4. The board 2 may be a standard traffic sign. A contour of the standard traffic sign is commonly seen in triangular shape, in circular shape or in other shapes. In the first embodiment, the board 2 has the contour in triangular shape as a warning triangle set up in a warning point, e.g. in rear side of a fault car. The board 2 has an inner side surface 21 and an outer side surface 22 in the opposite of the inner side surface 21. The inner side surface 21 faces toward the fault car while the outer side surface 22 faces toward other approaching cars behind the fault car. The inner side surface 21 has a power module 211 for connecting to an external power supply or accommodating batteries. The inner side surface 21 also has a display module 212, electrically connected to the power module 211. The display module 212 is used to display residual power capacity. The outer side surface 22 is installed with a number of reflective elements 221, e.g. reflective films, and a number of luminous elements 222, e.g. LED lamps, daylight lamps, fluorescent lamps or laser in all colors, electrically connected to the power module 211. The luminous elements 222 include a number of first luminous elements 2221 and second luminous elements 2222. The first luminous elements 2221 and the reflective elements 221 are interleavedly arranged on the outer side surface 22. The second luminous elements 2222 are installed outside the first luminous elements 2221 and the reflective elements 221 and close to an upper edge of the outer side surface 22. Colors of the luminous elements 222 are of high brightness and good penetration, such as red, yellow and orange, so that cars far away are able to quickly perceive the luminous elements 222 even under a poor sight condition to strength the effect of warning.

In order to facilitate operations, a switch 223 electrically connected to the power module 211 is installed on the outer side surface 22 of the board 2. The switch 223 is of manually switched type, remote control type or auto-sensing type to control on and off of the power module 211. Besides, an illuminator, e.g. a flashlight (not shown), electrically connected to the power module 211 can be also installed on the outer side surface 22 of the board 2. Thus, a simple lighting function is provided.

The locating unit 3 is electrically connected to the power module 211 and installed on the inner side surface 21 of the board 2. The locating unit 3 includes: a locater 31, an encoder 32, a first memory 33 and a signal transmitter 34. The locater 31 is a GPS satellite locater, generating a first locating information which is stored in the first memory 33 for recording a location of the board 2. The encoder 32 calculates and converts the first locating information to store in the first memory 33. The signal transmitter 34 fetches a calculated and converted first locating information from the first memory 33 and transmits it in the form of radio signal to the real-time monitoring unit 4. Thus, location of the board 2 can be known.

The real-time monitoring unit 4 wirelessly connected with the locating unit 3. The real-time monitoring unit 4 has a body 40 which can be used for users near the board 2 to carry. The real-time monitoring unit 4 includes: a signal receiver 41, a decoder 42, a second memory 43, a processor 44 and a buzzer 45. The signal receiver 41 receives the radio signal from the locating unit 3. The decoder 42 decodes the radio signal and stores a decoded radio signal in the second memory 43. The processor 44 fetches the decoded radio signal from the second memory 43, actively feeds back the decoded radio signal and directly initiate the buzzer 45. Thus, once the first locating information generated from the locating unit 3 is transmitted, with the real-time monitoring unit 4 actively feeding back the decoded radio signal and initiating the buzzer 45, light warnings, locating warnings, monitoring effects and sound warnings are provided according to the warning device 1 of the present invention so that users can be aware of where they are thereby.

According to the description mentioned above, the board 2 of the present embodiment as a warning triangle can be set up not only on the road, but also on an inner side of a trunk cover of the fault car. For example, a hanger 6 is mounted on the inner side surface 21 of the board 2 to hang the board 2 on an opened trunk cover (i.e. its level is equivalent to that of the rear windscreen) so that installation height of the warning triangle is increased to enhance visibility, achieving a better warning effect.

According to the description mentioned above, the body 40 of the real-time monitoring unit 4 can be made according to users' requirements to have a suitable shape and size for carrying. In the present embodiment, the body 40 is semicircular and has a size of a hand.

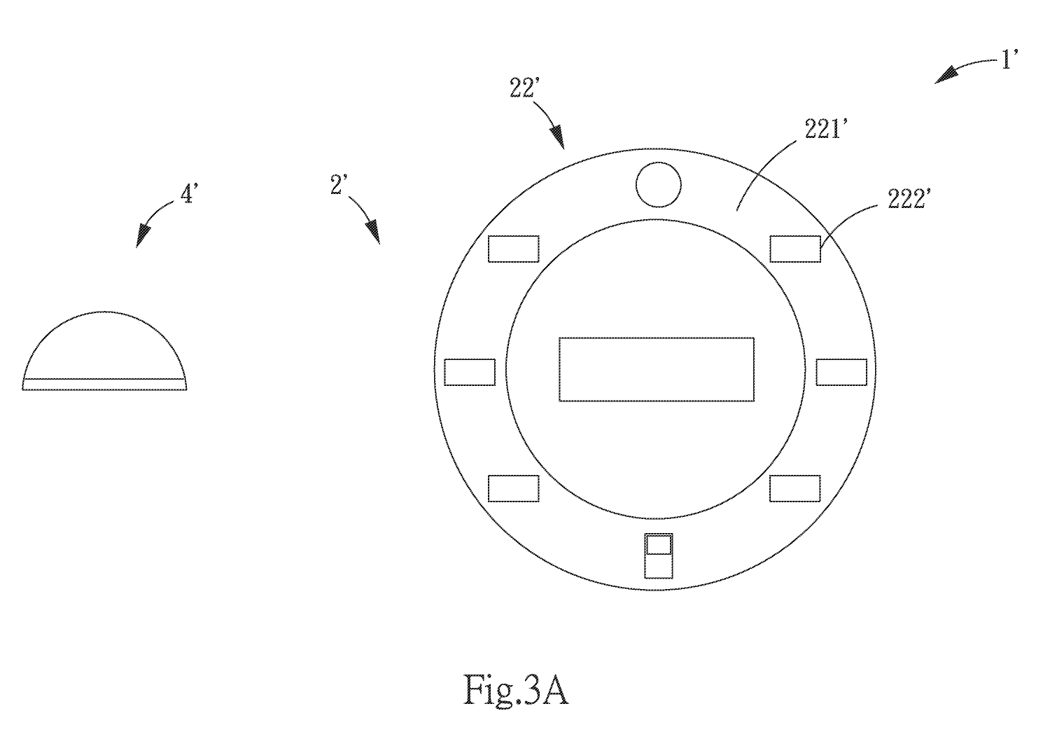

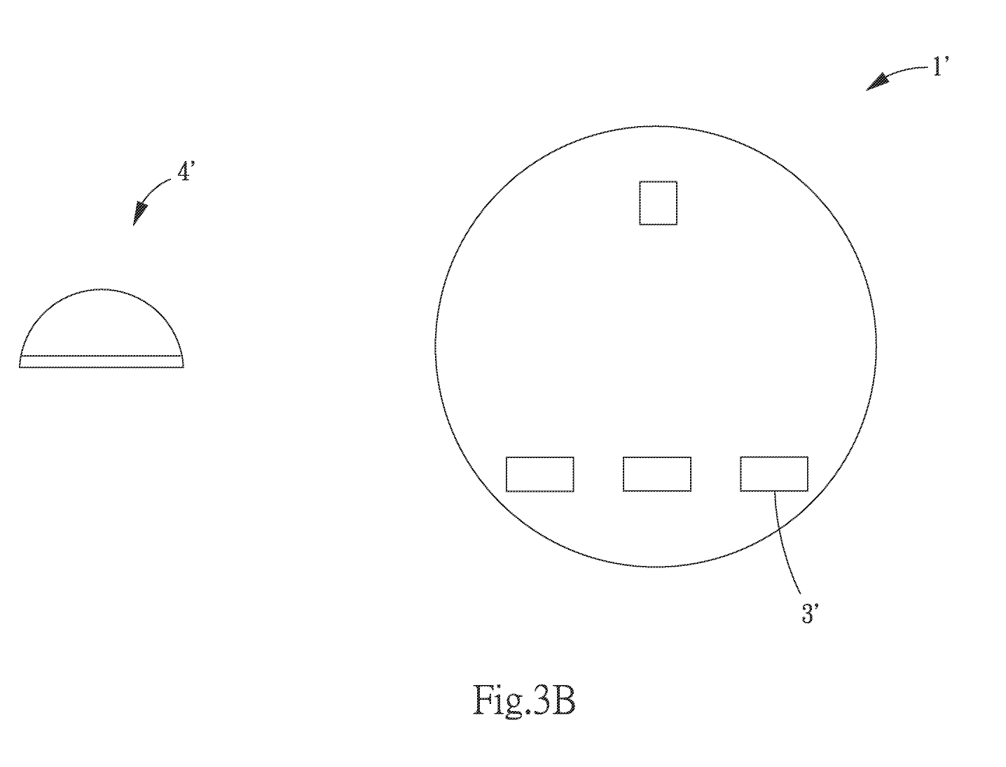

Please refer to FIG. 3A and FIG. 3B as a second embodiment of the present invention. A warning device 1′ in the present embodiment is substantially similar to the warning device 1 mentioned above. The warning device 1′ also includes a board 2′, a locating unit 3′ and a real-time monitoring unit 4′. The difference between the warning device 1′ and the warning device 1 is that the board 2′ is made in circular shape as a circular traffic sign rather than in triangular shape as the warning triangle (a contour of the board 2′ in the present embodiment is a circle. It is not limited to be a circle. Other shapes of standard traffic sign can be applied as well). A number of reflective elements 221′ are arranged as a strip shape in a central part of the outer side surface 22′ and also as a ring shape in an edge part thereof to show a traffic sign representing “no entry”. In addition, a number of luminous elements 222′ are arranged on surfaces of the reflective elements 221′ to further enhance warning effect of the traffic sign.

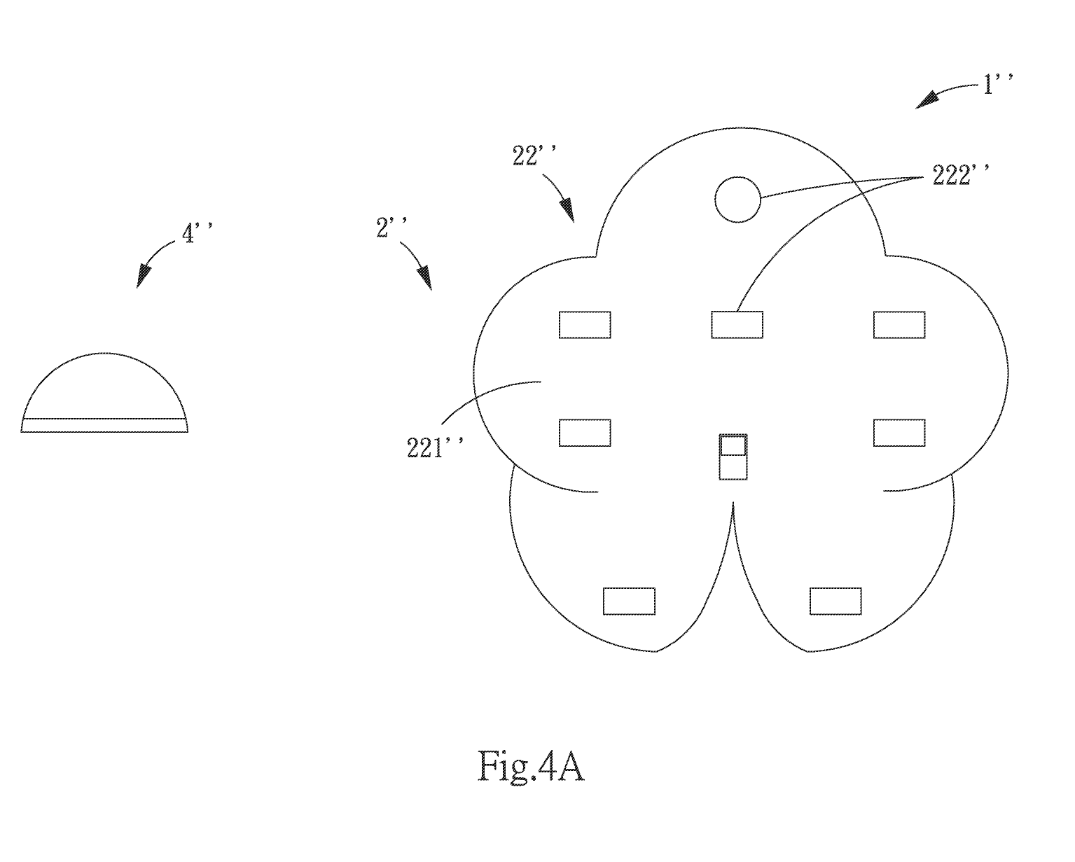

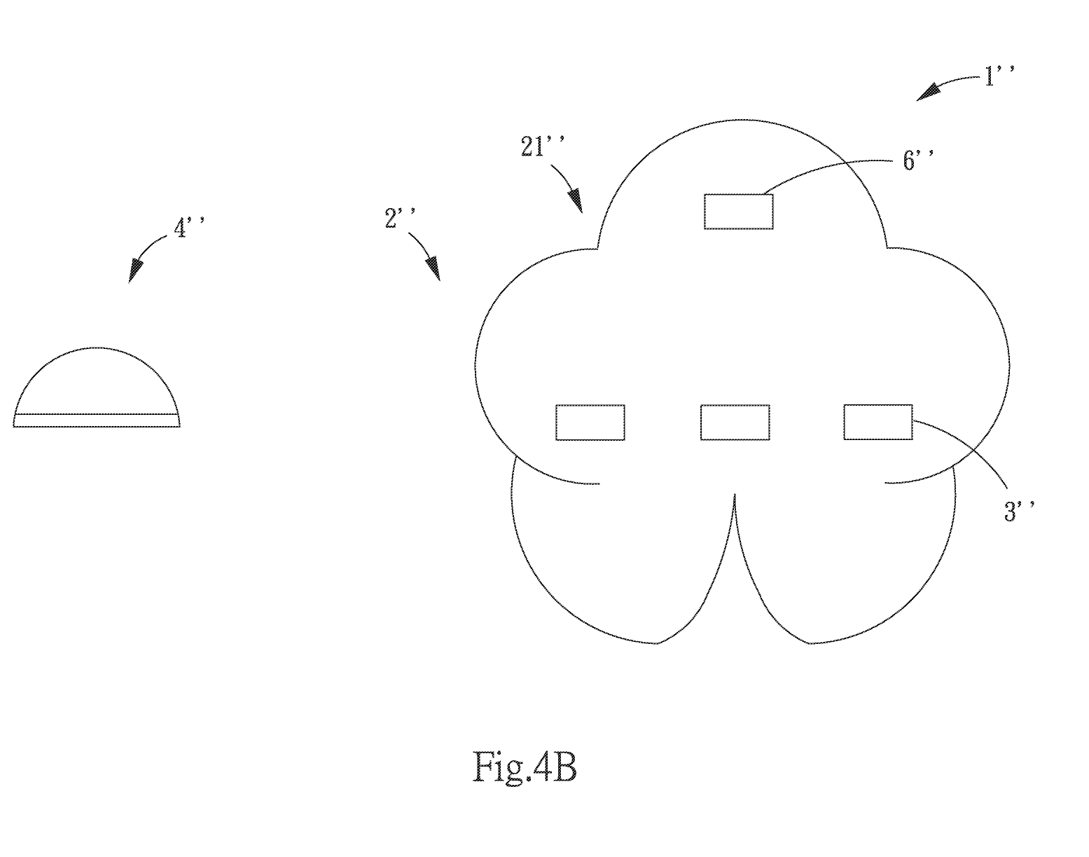

Please refer to FIG. 4A and FIG. 4B as a third embodiment of the present invention. A warning device 1″ in the present embodiment is substantially similar to the warning device 1 in the first embodiment and the warning device 1′ in the second embodiment. The warning device 1″ also includes a board 2″, a locating unit 3″ and a real-time monitoring unit 4″. The only difference is that a contour of the board 2″ can be made according to user preferences in a shape of a lovely badge, e.g. a gingerbread man. A hanger 6″ of the board 2″ can be made as a pin or a clip which can be fixed on children's clothes for them to use. A number of reflective elements 221″ are integrally formed and cover the outer side surface of the board 2″. There are a number of luminous elements 222″ arranged on the surfaces of the reflective elements 221″. When the board 2″ and the real-time monitoring unit 4″are equipped by the children and their caregivers, besides the light warnings of the board 2″ made by the reflective elements 221″ and luminous elements 222″, the real-time monitoring unit 4″ can actively feed back signals and initiate a buzzer, providing monitoring and warning sounds to point out the location where the user is. Monitoring and warning sound effects can thus be achieved. The mentioned board 2″ is equipped by children but not limited thereto. Old people, dementia patients, or mountaineers and people in ship wreck and air crash can use it. Locating is available when disaster relief is processing.

It is understood that the invention may be embodied in other forms within the scope of the claims. Thus the present examples and embodiments are to be considered in all respects as illustrative, and not restrictive, of the invention defined by the claims.

1. A warning device, comprising:
a board having an inner side surface and an outer side surface in the opposite of the inner side surface, the inner side surface having a power module connected to an external power supply or accommodating batteries, the outer side surface being installed with a number of reflective elements and a number of luminous elements connected to the power module;
a locating unit electrically connected to the power module and installed on the inner side surface of the board, the locating unit comprising: a locater, an encoder, a first memory and a signal transmitter, the locater generating a first locating information for recording a location of the board, the encoder calculating and converting the first locating information to store in the first memory, the signal transmitter fetching a calculated and converted first locating information from the first memory and transmitting it in the form of radio signal;
a real-time monitoring unit being separate from the board and wirelessly connected with the locating unit, the real-time monitoring unit further comprising: a body, and a signal receiver, a decoder, a second memory, a processor and a buzzer which are assembled in the body, the signal receiver receiving the radio signal from the locating unit, the decoder decoding the radio signal and storing the decoded radio signal in the second memory, the processor fetching the decoded radio signal from the second memory, actively feeding back the decoded radio signal and directly initiate the buzzer, wherein when the first locating information generated from the locating unit is transmitted, the real-time monitoring unit actively feeds back the decoded radio signal and initiates the buzzer, so that the real-time monitoring unit gives a sound warning in accordance with the location of the board.

2. The warning device of claim 1, wherein the locater is a global positioning system (GPS) satellite locater.

3. (canceled)

4. The warning device of claim 1, wherein the reflective elements are reflective films, and the luminous elements are LED lamps, daylight lamps, fluorescent lamps or laser.

5. The warning device of claim 1, wherein the luminous elements comprise a plurality of first luminous elements and a second luminous element, wherein the first luminous elements and the reflective elements are interleavedly arranged, and the second luminous element is located on an upper side of the first luminous elements and the reflective elements, and the luminous elements have light colors including red, yellow and orange so that cars far away are able to quickly perceive the luminous elements even under a poor sight condition to strength the effect of warning.

6. The warning device of claim 1, wherein a display module electrically connected to the power module is installed on the inner side surface of the board to display residual power capacity.

7. The warning device of claim 1, wherein a switch electrically connected to the power module is installed on the outer side surface of the board, wherein the switch is of manually switched type, remote control type or auto-sensing type to control on and off of the power module for conveniently operational use.

8. The warning device of claim 1, wherein an illuminator electrically connected to the power module is further installed on the outer side surface of the board for providing a simple lighting function, wherein the illuminator is a flashlight.

9. The warning device of claim 1, wherein the board is a traffic sign and a contour of the traffic sign is in triangular or circular contour shape, wherein the reflective elements are arranged as a strip shape in a central part of the outer side surface and also as a ring shape in an edge part thereof to show a sign representing “no entry”, and further, the luminous elements are arranged on surfaces of the reflective elements to enhance warning effect of the traffic sign.

10. The warning device of claim 1, wherein a contour of the board is made as a badge shaped as a gingerbread man, wherein the reflective elements are integrally formed to cover the outer side surface of the board, and surfaces of the reflective elements are arranged with the luminous elements, and when the board with the real-time monitoring unit is equipped by children and their caregivers, old people, dementia patients or mountaineers and people during ship wreck and air crash, in addition to light warning from the reflective elements and the luminous elements on the board, the real-time monitoring unit is able to actively feed back the decoded radio signal and initiate the buzzer to provide monitoring effects and sound warnings to point out where the user is.
